(19) United States
(12) Patent Application Publication
(10) Pub. No.: US 2004/0001155 A1
(43) Pub. Date: Jan. 1, 2004

(54) Data recording and reproducing apparatus

(75) Inventor: Koji Mizobuchi, Sagamihara-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 09/927,925

(22) Filed: Aug. 10, 2001

(30) Foreign Application Priority Data
Aug. 16, 2000 (JP) 2000-247031
Jul. 19, 2001 (JP) 2001-220003

(51) Int. Cl. H04N 5/76

(52) U.S. Cl. 348/231.3

(57) ABSTRACT

In a data recording and reproducing apparatus according to the present invention, audio/image signals are encoded by an encoding portion. A specific switch in a switch operation portion is operated only at the time of recording, and quantized image signals are selectively inputted to the encoding portion by a selection portion. Audio data and image data associated with the audio data are stored in a storage portion, and the audio data and the image data read from the storage portion are decoded by a decoding portion at the time of reproduction. The decoded audio signals are reproduced by an audio reproduction portion, and the decoded image signals are reproduced by an image reproduction portion. Only the image signals associated with the audio signals are selectively inputted to the image reproduction portion by the selection portion.

### CROSS-REFERENCE TO RELATED APPLICATIONS

This application is based upon and claims the benefit of priority from the prior Japanese Patent Applications No. 2000-247031, Aug. 16, 2000; and No. 2001-220003, filed Jul. 19, 2001; the entire contents of both of which are incorporated herein by reference.

### BACKGROUND OF THE INVENTION

The present invention relates to a data recording and reproducing apparatus. More particularly, it relates to a data recording and reproducing apparatus that has an imaging function.

In recent years, portable sound recording/reproducing apparatuses (hereinafter referred to as “IC recorders”) have been put to practical use. An IC recorder converts audio signals to digital data and stores the digital data into a flash memory used as a rewritable recording medium. The IC recorder can reproduce, whenever necessary, the audio signals from the digital data stored in the flash memory, by means of analog conversion.

The IC recorder is characterized in that it can operate in various modes such as recording mode, reproduction mode, fast-forward mode, and rewinding mode. These modes can be selected by operating the switches provided on the IC recorder.

In the recording mode, for example, audio data obtained by converting audio signals and the index information (i.e., address, recording date, and the like) about the audio data are stored into the audio data area and index information area, respectively, which are provided in the flash memory.

Electronic still cameras have been put to practical use, too. An electronic still camera can record not only image data but also audio data. The main data an electronic still camera stores is image data. Therefore, in electronic still cameras it is difficult to allocate enough storage area to audio data. This is because the camera has but a limited storage capacity. A small area is allocated to audio data, so small barely enough to hold audio data recorded for only tens of seconds and associated with one image.

To solve the problem, some techniques have been proposed. Jpn. Pat. Appln. KOKAI Publication No. 6-22258 discloses the technique of using a recording medium exclusively for audio data, along with another recording medium dedicated to image data. Further, in the invention disclosed in Jpn. Pat. Appln. No. 6-22258, each audio data item is stored in association with the time of starting the recording of the corresponding image data item. Thus, the audio data item can be reproduced the moment the corresponding image data item is reproduced.

An electronic still camera of this type may be used to record an image data item and the associated audio data item much larger than the image data item. For example, an interviewer may use the camera, taking pictures of some persons interviewed and recording the speeches of these persons. In this case, the amount of audio data recorded is far greater than that of image data recorded.

It suffices to record a picture of any person interviewed, in a resolution just enough to provided a picture that serves to recognize that person. That is, the picture need not be recorded in high resolution. In view of this, to use an electronic still camera to record audio data is a waste of the specialized function of the camera, i.e., the imaging function.

In such an interview as described above, the interviewer must keep holding the electronic still camera and move it from one position to another every time one person stops talking and another starts speaking, in order to record their speeches. This would be a troublesome task for the interviewer to do.

### BRIEF SUMMARY OF THE INVENTION

The present invention has been made in view of the foregoing. An object of the invention is to provide a data recording and reproducing apparatus which is easy to operate and is error-free and which enables easy recognition of the a person speaking and the speech he or she makes.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

A first object of the present invention is to provide a data recording and reproducing apparatus having a function of reproducing audio data and image data associated with the audio data, the apparatus comprising: audio data reproducing means for reproducing audio data; and display means for displaying, while the audio data reproducing means is reproducing audio data, first information including character data representing reproduction status of the audio data and for displaying second information including image data associated with the audio data being reproduced.

A second object of the invention is to provide a data recording and reproducing apparatus having audio data reproducing means for reproducing audio data selected, and display means for displaying at least image data associated with the audio data selected. This apparatus comprises: instruction means for instructing the display means to display or not to display the image data; control means for causing the display means to display data representing reproduction status of the audio data, when the instruction means instructs the display means not to display the image data.

A third object of the present invention is to provide a data recording and reproducing apparatus comprising: audio data recording means for recording audio data on a recording medium; imaging means for generating image data while the audio data recording means is recording the audio data; and image recording means for recording the image data on the recording medium, in association with that part of the audio data which is recorded the moment the imaging means generated the image data.

A fourth object of the present invention is to provide a data recording and reproducing apparatus capable of reproducing audio data and image data associated with that part of the audio data which is recorded the moment the image data is generated. This apparatus comprises: display means for displaying an operating status of the apparatus; and control means for causing the display means to display first information including character data representing a reproduction status of the audio data while the audio data is being reproduced, and for displaying second information including the image data associated with the part of the audio data, when the part of the audio data is reproduced.

A fifth object of the present invention is to provide a data recording and reproducing apparatus having a function of recording audio data and image data associated with the audio data. The apparatus comprises: audio data recording means for recording audio data; and imaging means imaging means for recording image data in association with a time elapsed in the process of recording the audio data, while the audio data recording means is recording the audio data.

A sixth object of the invention is to provide a data recording and reproducing apparatus having a function of recording audio data and image data associated with the audio data. This apparatus comprises: audio data reproducing means for reproducing audio data; and display means for displaying, while the audio data reproducing means is reproducing audio data, first information including character data representing reproduction status of the audio data and for displaying second information including image data associated with a time elapsed in the process of recording the audio data that the audio data reproducing means is reproducing.

A seventh object of the present invention is to provide a data recording and reproducing apparatus comprising: an audio recording section which converts audio signals to audio data and which records the audio data in a memory; an image recording section which encodes image signals generated by an imaging device, into image data, and which records the image data in the memory; on index information recording section which records index information about the audio data, the index information including data about the image data associated with the audio data.

An eighth object of this invention is to provide a data recording and reproducing apparatus comprising: a sound reproducing section which converts audio data recorded in a memory, into audio signals, thereby reproducing the audio data; an image reproducing section which converts the audio data recorded in the memory, into image signals, and causing a display device to display the image data; and control section which controls the image reproducing section in accordance with index information about the audio data recorded in the memory, while the sound reproducing section is reproducing the audio signals.

### DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing a schematic structure of an embodiment of a data recording and reproducing apparatus according to the present invention;

FIG. 2 is a view showing a block structure of an IC recorder which is a first embodiment according to the present invention;

FIG. 3 is a flowchart for illustrating a main operation of the IC recorder of the first embodiment according to the present invention;

FIG. 4 is a flowchart for illustrating an operation of a subroutine “recording processing” at a step S10 in the flowchart of FIG. 3;

FIG. 5 is an explanatory drawing showing a memory structure of a storage portion in the IC recorder according to the first embodiment;

FIG. 6 is a flowchart for illustrating an operation of a subroutine “image acquisition processing” at a step S24 in the flowchart of FIG. 4;

FIG. 7 is a flowchart for illustrating an operation of a subroutine “reproduction processing” at a step S11 in the flowchart of FIG. 3;

FIG. 8 is a flowchart for illustrating an operation of a subroutine “image reproduction processing” at a step S52 in the flowchart of FIG. 7;

FIGS. 9A and 9B show an exterior appearance structure of the IC recorder according to the first embodiment of the present invention, in which FIG. 9A is a top view and FIG. 9B is a front view showing the state of an operation display portion during recording;

FIGS. 10A and 10B illustrate the states of recording of a person speaking, and related voice/image reproduction by using the IC recorder shown in FIGS. 9A and 9B, in which FIG. 10A is a view for illustrating a recording operation cf the IC recorder and FIG. 10B is a view showing the state of reproduction of voice/image data of the IC recorder;

FIG. 11 shows a second embodiment according to the present invention and is a flowchart for illustrating an operation of a subroutine “image acquisition processing” at a step S24 in the flowchart of FIG. 4;

FIG. 12A is a view showing the relationship between an audio data area and an index information area in the second embodiment, and FIG. 12B is a view for illustrating a structure of the index information area in the second embodiment;

FIG. 13 is a flowchart showing the second embodiment according to the present invention and illustrating an operation of a subroutine “reproduction processing” at a step S11 in the flowchart of FIG. 3; and

FIG. 14 is a flowchart for illustrating an operation of a subroutine “image reproduction processing” at a step S96 in the flowchart of FIG. 13.

### DETAILED DESCRIPTION OF THE INVENTION

Embodiments according to the present invention will now be described hereinafter with reference to the accompanying drawings.

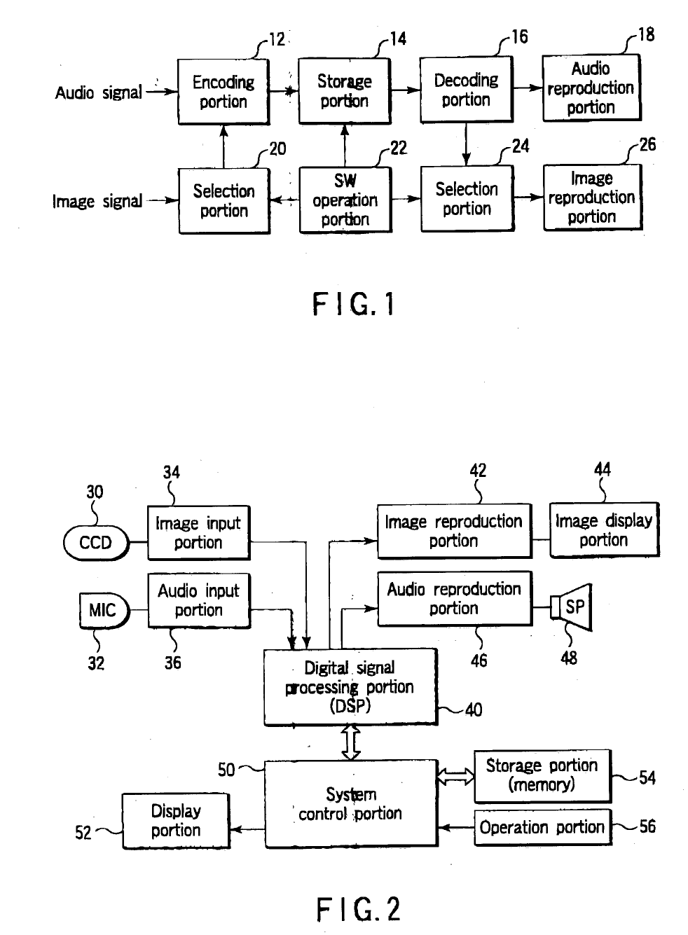

FIG. 1 is a block diagram showing a schematic structure of a first embodiment of a data recording and reproducing apparatus according to the present invention.

As shown in FIG. 1, a data recording and reproducing apparatus of this embodiment includes an encoding portion 12 for encoding an inputted signal into data having a predetermined encoding format, a storage portion 14 for storing the encoded data, a decoding portion for decoding data read from the storage portion 14 in accordance with a predetermined decoding format during reproduction, and an audio reproduction portion 18 for reproducing the decoded audio signal as a sound.

This data recording and reproducing apparatus is constituted by further comprising a switch (SW) operation portion 22 having a plurality of operation switches provided thereto, a first selection portion 20 for selectively inputting an image signal quantized by the switch operation of the switch operation portion 22 into the encoding portion 12 during recording, an image reproduction portion 26 for reproducing the decoded image signal as an image, and a second selection portion 24 for selectively inputting only image data associated with an elapsed recording time of the audio data into the image reproduction portion 26.

Further, the data recording and reproducing apparatus has an audio data storage area for storing audio data, image data storage area provided only when image data is stored and an index storage area for storing index information concerning each storage area being provided in the storage portion 14.

Furthermore, as a characteristic of the exterior appearance of the data recording and reproducing apparatus, an imaging lens for picturizing an image is provided on a microphone mounting surface (not shown).

The concrete structure of the data recording and reproducing apparatus according to this embodiment will now be described.

FIG. 2 is a view showing a block structure of an IC recorder according to an embodiment of the present invention.

In FIG. 2, this IC recorder is constituted by an imaging device (CCD) 30 for converting an image into an electric signal, a microphone (MIC) 32 for converting a sound into an electric signal, an image input portion 34, and an audio input portion 36.

The image input portion 34 receives image data supplied from the imaging device (CCD) 30 and is constituted by each control circuit (not shown) for, e.g., iris, gain, white balance and others, and an A/D converter. Each pixel signal outputted from the imaging device (CCD) 30 is converted into a digital signal by the image input portion 34.

Similarly, the audio input portion 36 receives sound supplied from the microphone (MIC) 32 and is constituted by a microphone amplifier, a low-pass filter and an A/D converter which are not shown. An unnecessary frequency band of an analog audio signal amplified by the microphone amplifier is cut by the low-pass filter, and the analog audio signal is then converted into a digital signal.

Each digital signal for the image and sound is input to a digital signal processing (DSP) portion 40. The portion 40 is controlled by a system control portion 50 in the recording mode. The portion 40 encodes (compresses) each digital signal into audio data and image data in units of frames. The audio data and the image data have a predetermined format. The data encoded is temporarily stored in a buffer memory (not shown) that is provided in the system control portion 50.

In the reproducing mode, too, the digital signal processing portion 40 is controlled by the system control portion 50. In the reproducing mode, the portion 40 decodes (decompresses) the audio data and the image data read from the buffer memory, in units of frames.

Then, the decoded image digital signal is inputted to an image reproduction portion 42. This image reproduction portion 42 is constituted by a video control circuit and a D/A converter which are not shown. The image signal converted into an analog signal by the image reproduction portion 42 is displayed as an image in an image display portion 44 constituted by, e.g., a TFT-LCD and the like.

Similarly, the decoded audio digital signal is inputted to an audio reproduction portion 46. The audio reproduction portion 46 is constituted by a D/A converter, a low-pass filter, and a power amplifier which are not shown. An unnecessary frequency band of an audio signal converted into an analog signal by the D/A converter is cut by the low-pass filter, and this audio signal is then amplified by the power amplifier Thereafter, the amplified signal is outputted as a sound.

To the system control portion 50 are connected a display portion 52, a storage portion (memory) 54 and an operation portion 56 as well as the digital signal processing portion 40.

The storage portion (memory) 54 is constituted by a non-volatile semiconductor memory, e.g., a flash memory and the like. At the time of recording, audio data and image data encoded by the digital signal processing portion 40 are stored through a buffer memory (not shown) in the system control portion 50. At this moment, index information concerning the audio data and the image data is also stored.

Although not shown, to the operation portion 56 are provided various switches such as a recording switch (REC), a reproduction switch (PLAY), a stop switch (STOP), a fast-forward switch (FF), a rewind switch (REW), a menu switch (MENU) and a hold switch (HOLD) in accordance with each function.

The display portion 52 displays an operation mode at the time of start of a predetermined sequence or a subsequent operation status by the operation of any switch of the operation portion 56. For example, when the recording switch (REC) is pressed, an elapsed recording time, a remaining recordable time, a file number and others are displayed. Moreover, when the menu switch (MENU) is pressed, display concerning selection of functions such as microphone sensitivity (high/low), a recording mode (standard/long), alarm (on/off) and others is performed.

In addition, when the system control portion 50 performs a clock function, current date and time are also displayed. These display contents may be displayed in the image display portion 44.

The operation of the IC recorder having such a structure will now be described.

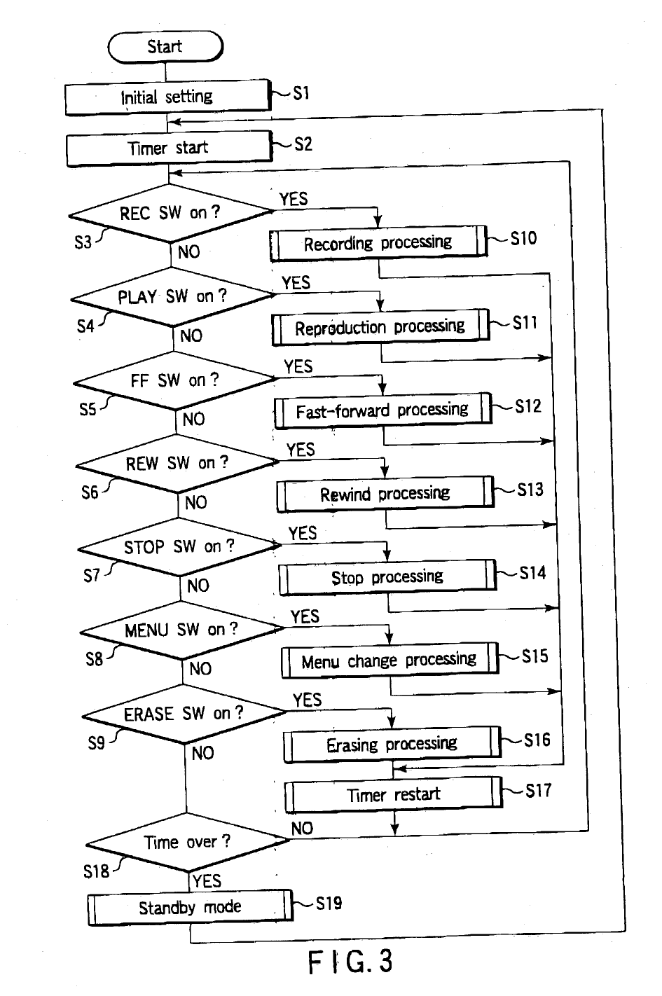

FIG. 3 is a flowchart for illustrating a main operation of the IC recorder according to this embodiment.

When the IC recorder is turned on, predetermined initial setting is first carried out by the system control portion 50 at the step S1. Subsequently, at the step S2, a timer (not shown) is started. This timer is used for clocking a time required for the IC recorder to enter from the usual operation mode to a standby mode (low-current-consumption mode) after passage of a predetermined time.

When the IC recorder enters the operation mode, the switch detection operation detects whether there is any switch which has been turned on by checking a recording switch (RECSW), a reproduction switch (PLAYSW), a fast-forward switch (FFSW), a rewind switch (REWSW), a stop switch (STOPSW), a menu switch (MENUSW), an erasing switch (ERASESW) in the mentioned order at the steps S3 to S9.

That is, if a switch which has been turned on is the recording switch (step S3), processing proceeds to the step S10 where a subroutine “recording processing” is executed. In addition, if a switch which has been turned on is a reproduction switch (step S4), processing proceeds to the step S11 where a subroutine “reproduction processing” is executed.

Similarly, if a switch which has been turned on is the fast-forward switch (step S5), processing proceeds to the step S12 where a subroutine “fast-forward processing” is executed. If a switch which has been turned on is a rewind switch (step S6), processing proceeds to the step S13 where a subroutine “rewind processing” is carried out.

Additionally, if a switch which has been turned on is the stop switch (step S7), processing advances to the step S14 where a subroutine “stop processing” is executed. Further, if a switch which has been turned on is the menu switch (step S8), the processing proceeds to the step S15 where a subroutine “menu change processing” is executed. Furthermore, if a switch which has been turned on is the erasing switch (step S9), processing advances to the step S16 where a subroutine “erasing processing” is performed.

After each subroutine is executed at the steps S10 to S16 mentioned above, the timer which has been started at the step S2 is reset and again started (step S17). Thereafter, the processing proceeds to the step S3.

It is to be noted that “fast-forward processing”, “rewind processing”, “stop processing”, “menu change processing” and “erasing processing at the above-described steps S12 to S16 are carried out by using well-know means. This doesn't directly relate to the content of the present invention, and its detailed explanation is hence omitted here.

If all the switches are in the off state at the steps S3 to S9, the clocking time of the timer which has been restarted at the step S2 is judged at the step S18. Here, if the clocking time is within a predetermined time, the processing proceeds to the step S3, and the operation for detecting the switches is again performed. On the other hand, if the clocking time exceeds the predetermined time, the processing advances to the step S19 and a subroutine “standby mode” is carried out. In the “standby mode”, the low-current-consumption operation is effected.

Specifically, the power supply for the image input portion 34, the audit input portion 36, the digital signal processing portion (DSP) 40, the image reproduction portion 42, the image display portion 44, the audio reproduction portion 46, the display portion 52 and the storage portion 54 is interrupted, or a non-selected signal is outputted from the system control portion 50 to a chip enable terminal provided to a non-illustrated IC constituting each block, thereby realizing the low-current-consumption state.

At this moment, the CPU (not shown) itself in the system control portion 50 switches the operation clock to a low-speed clock having the least consumption current and enters the low-current-consumption state. Alternatively, the operation clock may be switched from a main clock (for example, 9.28 MHz) to a sub clock (for example, 32.768 kHz) so that the main clock is completely stopped until a switch input is detected.

Description will now be given as to a subroutine “recording processing” at the step S10 in a flowchart of FIG. 3 with reference to a flowchart of FIG. 4 and FIGS. 2 and 5.

When the recording processing operation is started, at the step S21, various kinds of information such as the microphone sensitivity (high/low), a recording mode (standard/long), a file number, an audio data storage area start address for storing the audio data, and others are first stored in the index information area.

Subsequently, at the step S22, the ON/OFF state of a release switch (RELSW) which functions only at the time of recording is detected. Here, if the release switch (RELSW) is not in the ON state, the processing advances to the step S24. On the other hand, if the release switch (RELSW) is in the ON state, the processing proceeds to the step S23 where an image acquisition flag is set. Thereafter, the processing advances to the step S24.

At the step S24, a subroutine “image acquisition processing” is executed. Then, at the step S25, an audio signal is encoded by the digital signal processing portion (DSP) 40. It is to be noted that encoding is carried out in units of frames, and this processing is continuously effected until the audio data reaches a predetermined number of frames at the step S26.

Subsequently, if the audio data stored in a buffer memory (not shown) of the system control portion 50 has reached a predetermined number of frames, the processing advances to the step S27. At the step S27, the audio data is sequentially written and stored from an audio data storage area start address in the storage portion (memory) 54.

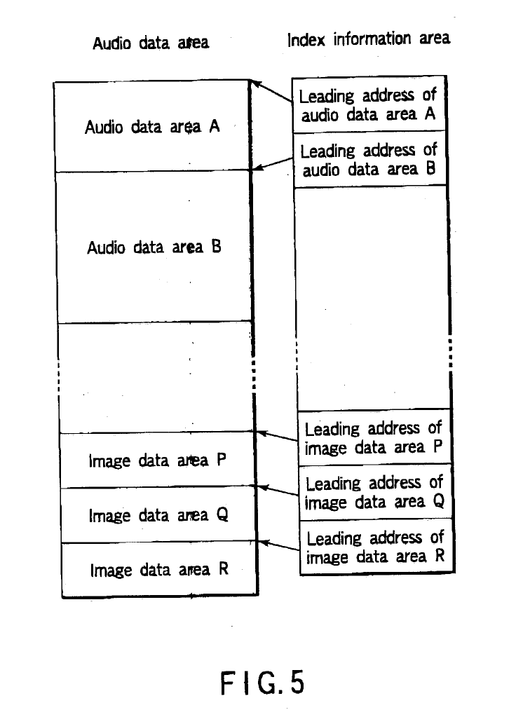

As shown in FIG. 5, an audio data area A and an audio data area B are sequentially stored from, e.g., leading addresses of the audio data areas. Furthermore, the start addresses corresponding to the audio data areas A and B are stored in the index information area, as a leading address of the audio data area A and a leading address of the audio data area B. Similarly, the leading address of the other audio data areas C, D, E, . . . are stored in the index information area every time these audio data areas are provided in the order they are mentioned.

Then, at the step S28, the image acquisition flag is detected. Here, if the image acquisition flag is not 0, the processing proceeds to the step S22, and the above-described processing is repeated. Moreover, if the image acquisition flag is 0, the processing advances to the step S29, and the state of the stop switch (STOPSW) is detected.

At this step S29, if the stop switch (STOPSW) is not in the ON state, the processing proceeds to the step S22, and the subsequent processing (steps S22 to S28) is repeated. On the other hand, if the stop switch (STOPSW) is in the ON state, the processing advances to the step S30, and the recording termination processing is executed, thereby completing recording.

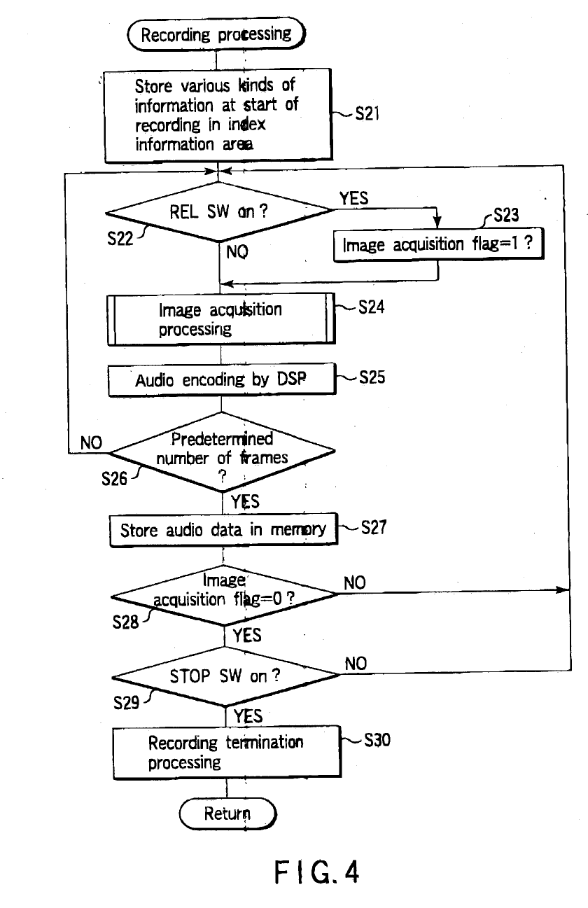

Description will now be given as to a subroutine “image acquisition processing” at the step S24 in a flowchart of FIG. 4 with reference to a flowchart of FIG. 6 and FIGS. 2 and 5.

Upon entering this subroutine “image acquisition processing”, whether the image acquisition flag is set is first detected at the step S41. Here, if the image acquisition flag is not set, the usual recording processing is executed. On the other hand, if the image acquisition flag is set, the processing advances to the step S42 where the image signal is encoded by the digital signal processing portion (DSP) 40.

Encoding itself is carried out in units of frames, similar to the encoding of audio data. Then, at the step S43, this encoding processing is continuously performed until the image data reaches a predetermined number of frames. At the step S43, when the audio data stored in the buffer memory (not shown) of the system control portion 50 reaches a predetermined number of frames, the processing proceeds to the step S44, and the audio data is sequentially written and stored from the audio data storage area start address in the storage portion (memory) 54.

As shown in FIG. 5, the start addresses of the image data area are sequentially stored from, e.g., the last address of the audio data area. Further, the start addresses corresponding to an image data area P, an image data area Q and an image data area R are stored in the index information area as a leading address of the image data area P, a leading address of the image data area Q and a leading address of the image data area R. The leading address of each image data is stored in the index information area every time when an image data area is provided to hold the image data, in the same way as the leading address of the audio data areas are stored in the index information area.

It is to be noted that the steps S41 to S44 are repeatedly performed till the image acquisition is terminated at the step S45. Moreover, upon completing the image acquisition at the step S45, an audio data associating flag is set at the step S46. Subsequently, when the image acquisition flag is reset at the step S47, this routine is terminated.

In addition, the audio data associating flag will be described in detail in the later-described subroutine “image reproduction processing”.

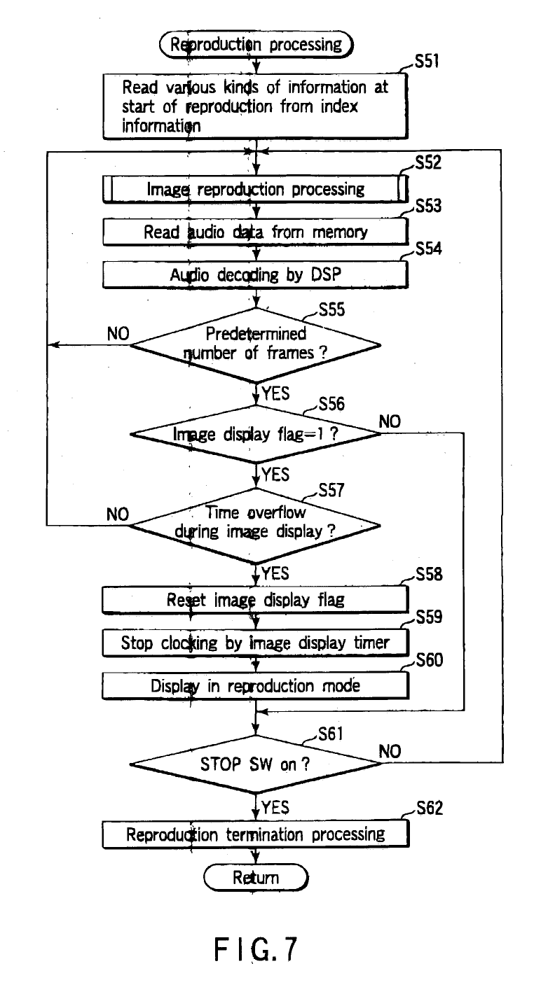

Description will now be given as to the operation of a subroutine “reproduction processing” at the step S11 in a flowchart of FIG. 3 with reference to a flowchart of FIG. 7 and FIG. 2.

When the reproduction processing starts, at the step S51, various kinds of information such as a recording mode (standard/long) concerning a selected audio data area, a file number, an audio data storage area start address at which this audio data is stored, and others are first read from the index information area.

Subsequently, at the step S52, a subroutine “image reproduction processing” is executed by the system control portion 50. Thereafter, at the step S53, the audio data stored in the storage portion (memory) 54 is sequentially read starting from the audio data storage area start address.

Further, at the step S54, the audio data is decoded by the digital signal processing portion (DSP) 40. Since decoding itself is carried out in units of frames, this decoding processing is continuously carried out until the audio data reaches a predetermined number of frames at the step S55. The audio data is outputted to the audio reproduction portion 46 as audio signals while sequentially being stored in the buffer memory (not shown) of the system control portion 50.

When decoding of a predetermined number of frames of the audio data is completed at the step S55, the state of a image display flag is judged at the subsequent step S56. Here, when the image display flag is set, display of an image is carried out in the display portion 52 concurrently with start of reproduction of the sound.

Usually, it takes only a few seconds to recognize the person speaking, after the start of displaying the picture of that person. In the step S57, it is determined whether the time an image display timer started measuring at the start of a sub-routine (later described) has reached a preset value or not. If the time has not reached the preset value, the steps S51 to S56 will be repeated. Otherwise, the process goes to the step S58, in which the image display flag is reset.

Furthermore, at the step S59, clocking by the image display timer is stopped. Subsequently, at the step S64, display in the usual reproduction mode (a recording time, an elapsed reproduction time, a recording mode (standard/long), a file number and others) is performed.

It is to be noted that the steps S52 to S56 are repeated until the stop switch (STOPSW) is turned on at the step S61. If the stop switch (STOPSW) is turned on at the step S61, the processing proceeds to the step S62 there the reproduction termination processing is executed and reproduction is completed.

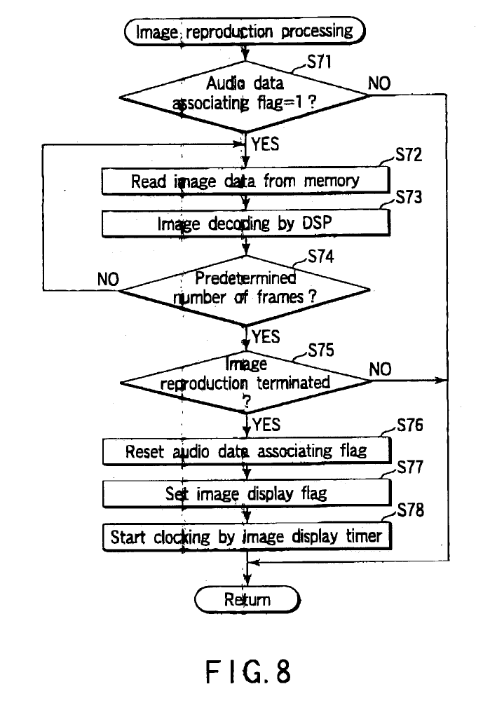

The operation of a subroutine “image reproduction processing” at the step S52 in a flowchart of FIG. 7 will now be described with reference to a flowchart of FIG. 8 and FIG. 2.

For example, at the step S71, whether an audio data associating flag is set is detected. Here, if this flag is not set, the usual reproduction processing is executed. However, if it is set, the processing proceeds to the step S72, and image data stored in the storage portion (memory) 54 is sequentially read from the image data storage area start address. This read image data is decoded by the digital signal processing portion (DSP) 40 at the step S73.

Since decoding itself is carried out in units of frame as similar to decoding of the audio data, this decoding processing is continuously carried out till the image data reaches a predetermined number of frames at the step S74. Then, the image data is outputted to the image reproduction portion 42 as image signals while sequentially being stored in a butter memory (not shown) in the system control portion 50.

The steps S71 to S74 are repeatedly performed by the system control portion 50 till image reproduction at the step S75 is terminated. After image reproduction is terminated, the processing proceeds to the step S76, and the audio data associating flag is reset by the system control portion 50. Subsequently, the image display flag is set at the step S77. When clocking by the image display timer is started at the step S78, the image reproduction processing is terminated.

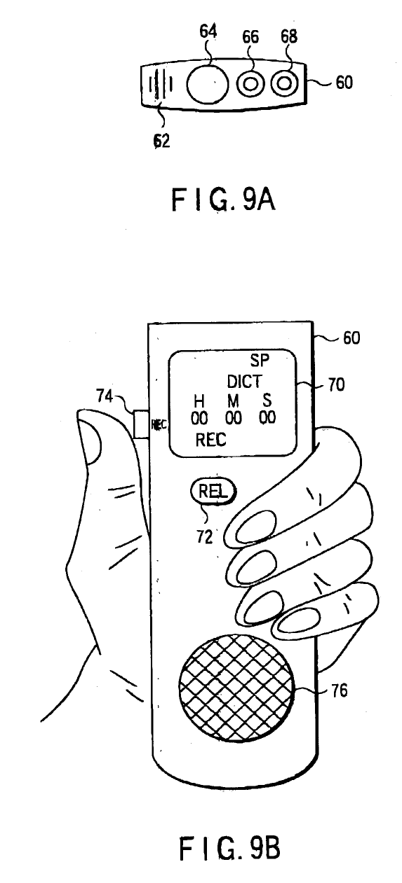

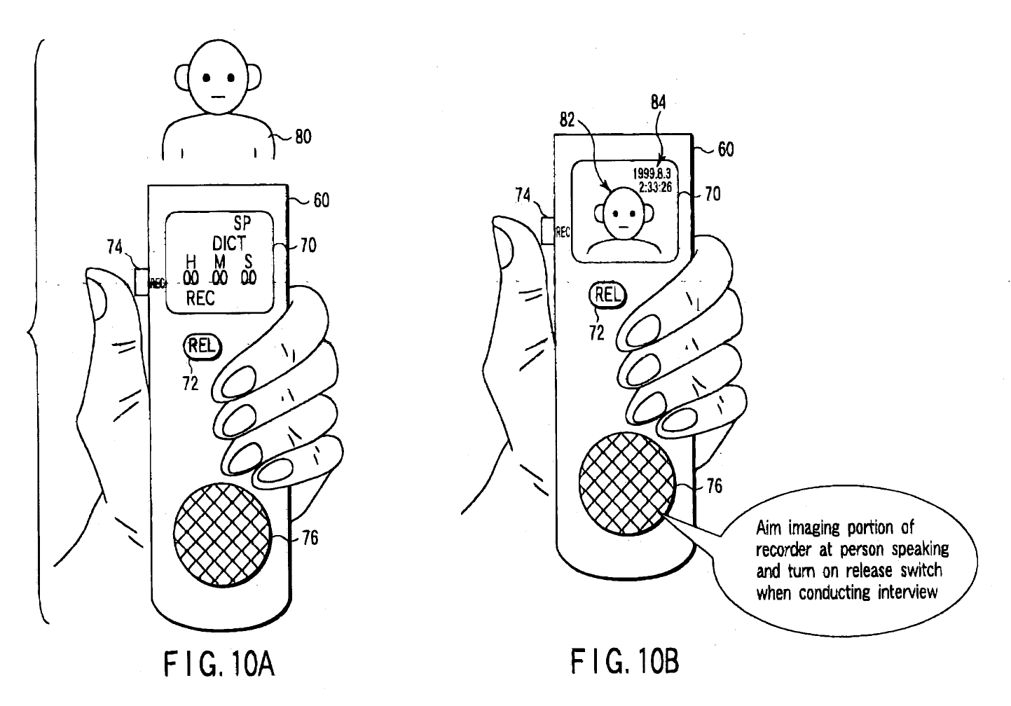

Description will now be given as to how an image is acquired at the time of recording in the IC recorder with reference to FIGS. 9A, 9B, 10A and 10B.

FIGS. 9A and 9B show the exterior structural appearance of the data recording and reproducing apparatus (IC recorder) according to this embodiment, in which FIG. 9A is a top view and FIG. 9B is a front view showing the state of the operation display portion during recording.

A microphone hole 62, an imaging lens 64, a microphone jack 66 and an earphone jack 68 are provided on the top surface of the IC recorder 60 according to this embodiment. Moreover, the microphone (MIC) 32 and the imaging device (CCD) 30 shown in FIG. 2 are respectively provided at positions opposed to the microphone hole 62 and the imaging lens 64. These members are arranged in such a manner that an orientation direction of the microphone 32 and an imaging direction of the imaging lens 64 are substantially the same, and an operator can hence smoothly perform image acquisition without awkwardness.

In addition, a display portion 70 corresponding to the image display portion 44 is provided on the front surface portion of the IC recorder 60. Additionally, a release switch (RELSW) 72 is provided at the lower portion of the display portion 70 and a recording switch (RECSW) 74 is provided on the side surface portion of the IC recorder 60 in the vicinity of the display portion 70, respectively.

Incidentally, although not shown, operation switches other than the recording switch (RECSW) 74 and the release switch (RELSW) 72 are arranged on the front surface or the side surface side of the IC recorder 60 in order to facilitate the operation.

Further, a spearer hole 76 is provided at the lower power of the front surface of the IC recorder 60. Furthermore, a speaker (SP) 48 shown in FIG. 2 is provided at a position opposed to the speaker hole 76 inside the IC recorder 60.

Moreover, as the above-described operation switches, feather-touch switches which are usually referred to as tactile push switches are used.

Description will now be given as to how recording of a person's voice and reproduction of sounds/images thereof are performed by using the IC recorder having such a structure with reference to FIGS. 10A and 10B.

The recording operation of the IC recorder 60 will first be explained with reference to FIG. 10A.

When the recording switch 74 of the IC recorder 60 is turned on, recording is started. At this moment, an initial screen at the start of recording is displayed on the display portion 70, and an operator is informed of the fact that the IC recorder 60 is currently in the recording operation state. In this state, as shown in FIG. 10A, when the release switch (REL) 72 is turned on with the top surface of the IC recorder 60 being pointed towards the person speaking 80, an image of the person can be acquired.

Image acquisition is carried out every time the release switch (REL) 72 is turned on. Therefore, an image of each person corresponding to their voice can be clearly recorded even in an interview and the like coping with a plurality of people.

Further, in order to clearly record an image, an image captured by the imaging lens 64 may be displayed on the display portion 10 as shown in FIG. 10B for a while after the release switch (REL) 72 is turned on. Furthermore, after framing of a subject is determined, the image may be captured by turning on the release switch (REL) 72, to execute image acquisition.

Description will now be given as to the state of image reproduction during reproduction using this IC recorder with reference to FIG. 10B.

When a reproduction switch (not shown) provided on the front surface portion or the side surface of the IC recorder 60 is turned on, reproduction is started. At this moment, such sound as shown in a speech balloon in FIG. 10B, for example, are emitted from the speaker 76. At the same time, an image 82 of the person speaking is displayed on the display portion 70. Therefore, since the speaker himself/herself can be visually confirmed while listening to the speech content, this processing is very effective particularly for interviews and the like where the speech contents of a plurality of people are recorded in accordance with each person and the recorded content is later documented. In this case, date information 84 such as date and hour of recording may be displayed on the display portion 10 together with the image 82 of the utterer.

Moreover, an image displayed on the display portion 70 may be displayed until reproduction of sounds concerning this image is terminated, or it may be of course displayed for only a predetermined time after start of reproduction as mentioned above.

In addition, if image recognition is unnecessary, an image may not be displayed. For example, if an image concerning sound is not recorded, display at the time of usual reproduction (a recording time, an elapsed reproduction time, a recording mode (standard/long), a file number and others) is effected.

As described above, according to the data recording and reproducing apparatus according to the first embodiment, since the person speaking can be visually confirmed while listening to the speech content during reproduction, this processing is every effective particularly for the interview and the like in which the speech contents of a plurality of people are recorded in accordance with each person and the recorded contents are later documented.

Additionally, since image data and audio data are both stored in the non-volatile memory, no cost increase occurs.

Further, since the imaging lens is provided in the coaxial direction with the orientation direction of the microphone, an operator can smoothly execute image acquisition during recording without awkwardness. Furthermore, the speakers voice rarely grates.

A second embodiment according to the present invention will now be described.

The schematic structure of the data recording and reproducing apparatus according to the second embodiment is the same as the apparatus shown in FIG. 1 in the first embodiment mentioned above.

In the data recording and reproducing apparatus having the structure shown in FIG. 1, quantized audio signals and image signals are encoded into audio data and image data having predetermined encoding formats by the encoding portion 12. Moreover, the audio data and the image data associated with an elapsed recording time of the audio data are stored in the storage portion 14, respectively.

Here, each of the audio data and the image data read from the storage portion 14 is decoded into audio signals and image signals by the decoding portion 16 in accordance with predetermined decoding formats. The decoded audio signals are reproduced as sounds by the audio reproduction portion 18. In addition, only the image data associated with the elapsed recording time of the audio data is inputted to the image reproduction portion 26 by the selection portion 24 and decoded so that image signals are reproduced as an image.

Additionally, at the time of recording, when a specific switch in the switch operation portion 22 is operated, the quantized image signals are selectively inputted to the encoding portion 12 by the selection portion 20.

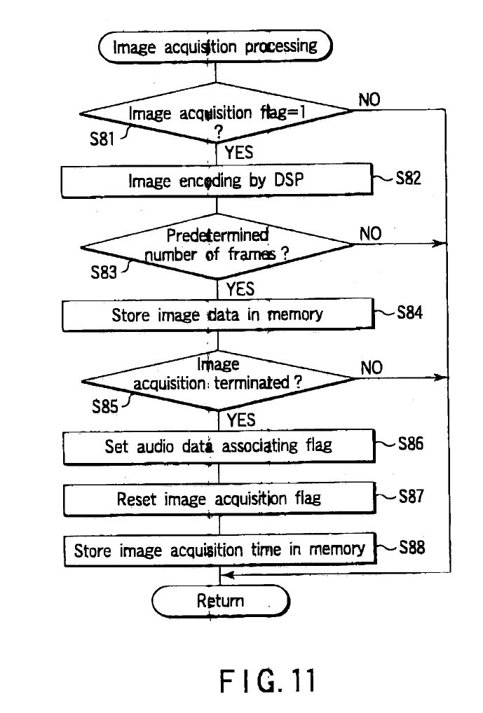

Description will now be given as to the operation of a subroutine “image acquisition processing” at the step S24 in a flowchart of FIG. 4 according to the second embodiment with reference to a flowchart of FIG. 11 and FIGS. 2, 5 and 12A.

In the above-described first embodiment, description has been given as to an instance where each audio data area is sequentially recorded from the leading address of the audio data area, and the start address of each image data area is sequentially recorded from the last address of the audio data area.

In the second embodiment, description will be given as to the case where a plurality of sets of image data are associated with one audio data file.

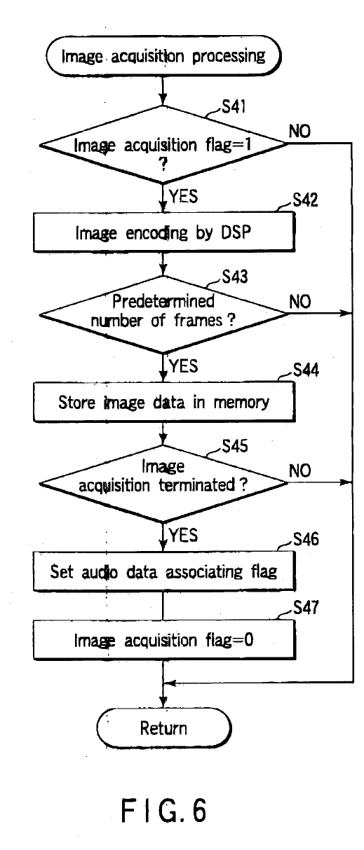

Upon entering the subroutine “image acquisition processing” whether the image acquisition flag is set is first detected at the step S81. The processing operation of the steps S81 to S84 is the same as that of the above-mentioned steps S41 to S44 in the flowchart shown in FIG. 6, thus the explanation is omitted.

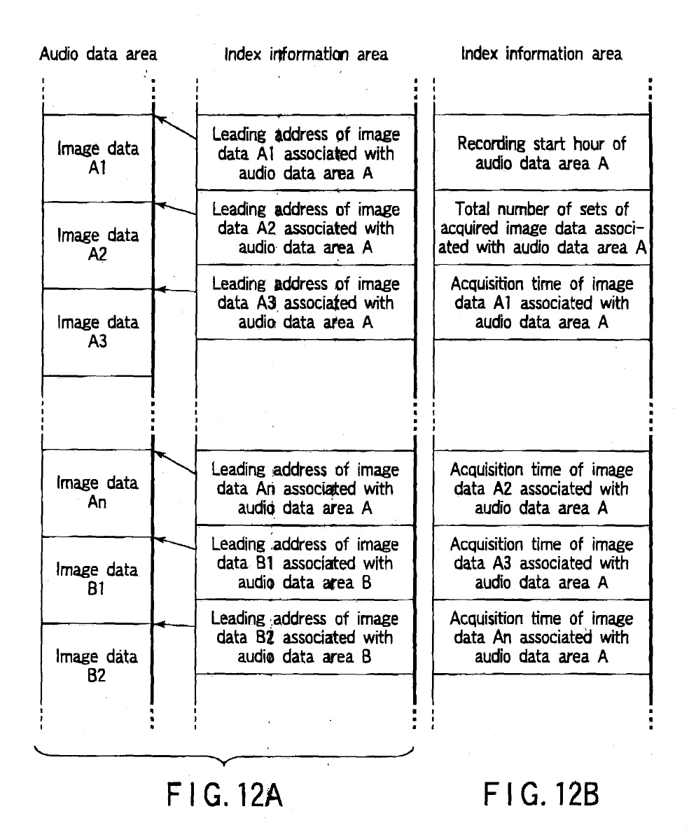

As shown in FIG. 12A, a plurality of sets of image data is associated with one audio data file (for example, corresponding to an audio data area A). In this case, it suffices to store the start addresses corresponding to the sets of image data, A1 to An, into the index information area, as leading addresses of the sets of image data, A1 to An, associated with the audio data area A. It is good enough that the image data items associated with audio data areas are stored in the index information area every time audio data areas B, C, . . . for these data items are sequentially secured.

The steps S81 to S84 mentioned above are repeatedly carried out until image acquisition is terminated at the step S85, and the audio data associating flag is set at the step S86 after termination of image acquisition at the step S85. Subsequently, when the image acquisition flag is reset at the step S87, an image acquisition hour is stored in the memory at the step S88, and this routine is then terminated.

It is to be noted that the audio data associating flag will be described in detail in the later-described subroutine “image reproduction processing”.

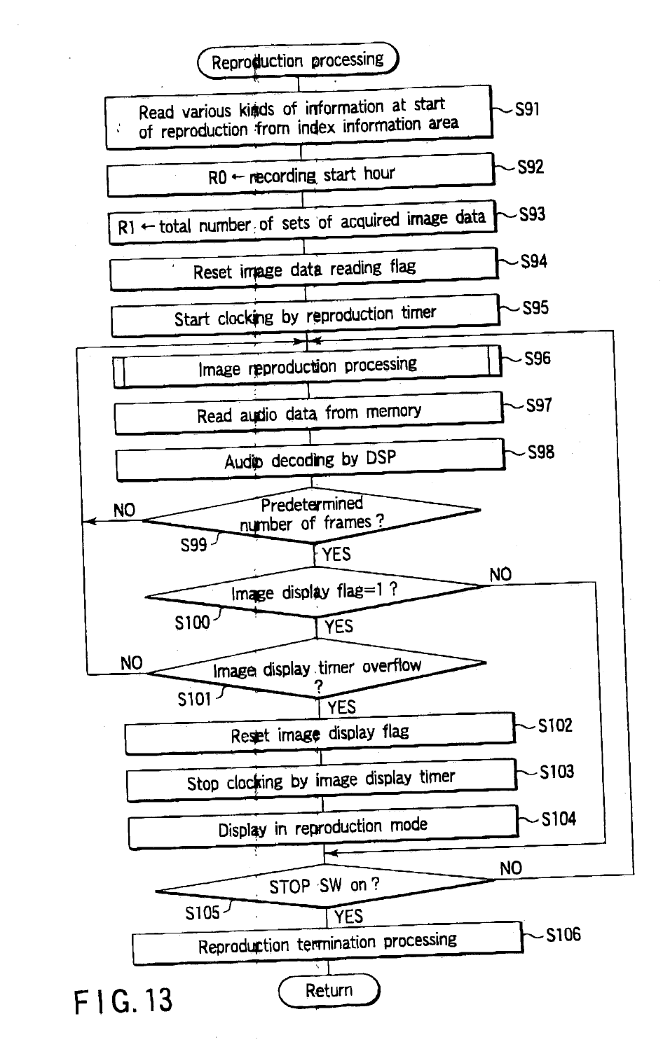

Description will now be given as to the operation of a subroutine “reproduction processing” at the step S11 in a flowchart of FIG. 3 according to the second embodiment with reference to a flowchart of FIG. 13 and FIG. 2.

Upon starting the reproduction processing, various kinds of information such as a recording mode (standard/long) associated with a selected audio data area, a file number, an audio data storage area start address at which this audio data is stored and others are first read from the index information area at the step S91.

Then, as processing before executing the later-described subroutine “image reproduction processing” at the step S96, a recording start hour is set in a register R0 at the step S92. Similarly, at the step S93, a total number of sets of acquired image data is set in a register R1. At the subsequent step S94, a flag in image data reading flag is reset. Then, at the step S95, clocking by a reproduction timer is started.

Further, at the step S96, the subroutine “image reproduction processing” is executed by the system control portion 21. The processing operation of the subsequent steps S97 to S106 is the same as that of the above-described steps S53 to S62 in the flowchart of FIG. 7, thus the explanation is omitted.

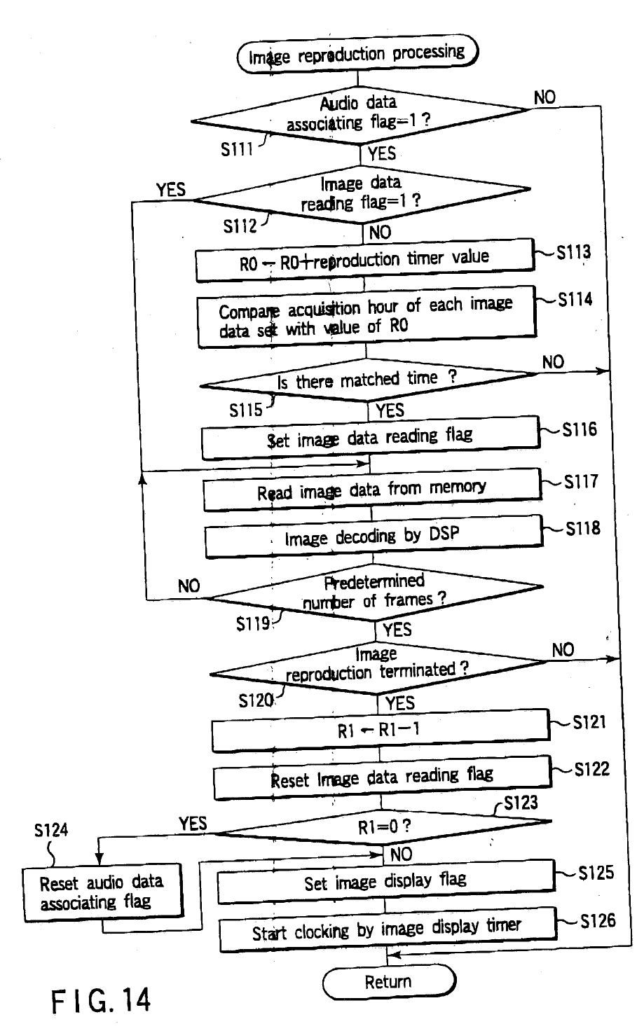

Description will now be given as to a subroutine “image reproduction processing” at the step S96 in a flowchart of FIG. 13 with reference to a flowchart of FIG. 14 and FIGS. 2 and 12B.

For example, at the step S111, whether the audio data associating flat is set in a selected audio data area A is first detected. Here, the usual reproduction processing is executed if this flag is not set.

However, if it is set, the processing advances to the step S112 where the state of the image data reading flag is judged.

At the step S112, if the image data reading flag is not reset, the processing proceeds to the step S117. If it is reset, the processing advances to the step S113. At this step S113, a clocking value of the reproduction timer is added to a value of the above-described register R0 (recording start hour). Then, at the step S114, the acquisition hours of the respective sets of image data A1 to An are compared with the value of R0.

Subsequently, at the step S115, whether there is a matched time between the acquisition hours and the value of R which have been compared with each other is detected. Here, it there is no matched time, the usual reproduction processing is continued. However, if there is a matched time, the processing proceeds to the step S116 where image data reading flag is set.

Then, at the step S117, the image data stored in the storage portion (memory) 54 is sequentially read from the image data storage area start address. This read image data is decoded by the digital signal processing portion (DSP) 40 at the step S118.

Decoding itself is carried out in units of frames similar to the decoding of audio data, and this decoding processing is hence continuously performed until the image data reaches a predetermined number of frames. Then, the image data is outputted to the image reproduction portion 42 as image signals while being sequentially stored in the buffer memory (not shown) in the system control portion 40.

The steps S111 to S119 mentioned above are repeatedly carried out until image reproduction at the step S120 is terminated. Upon completing image reproduction, the processing advances to the step S121, and the above-described value of the register R1 (a total number of sets of acquired image data) is decremented. Subsequently, at the step S122, the image data reading flag is reset.

Further, at the step S123, the value of the register R1 is detected. Here, if the register R1 is “0”, the processing proceeds to the step S124. At this step, it is determined that all sets of image data A1 to An concerning the audio data area A are reproduced, and the image data associating flag is reset so as not to perform image reproduction. Then, the processing advances to the step S125.

On the other hand, at the step S123, if the value of the register R1 is not “0”, all the sets of image data A1 to An concerning the audio data area A are not reproduced. Therefore, the processing proceeds to the step S125, and the image display flag is set. Then, at the step S126, clocking by the image display timer is started, and the usual reproduction processing is continued and thereafter terminated.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data recording and reproducing apparatus having a function of reproducing audio data and image data associated with the audio data, said apparatus comprising:
audio data reproducing means for reproducing audio data; and
display means for displaying, while the audio data reproducing means is reproducing audio data, first information including character data representing reproduction status of the audio data and for displaying second information including image data associated with the audio data being reproduced.

2. A data recording and reproducing apparatus having audio data reproducing means for reproducing audio data selected, and display means for displaying at least image data associated with the audio data selected, said apparatus comprising:
instruction means for instructing the display means to display or not to display the image data;
control means for causing the display means to display data representing reproduction status of the audio data, when the instruction means instructs the display means not to display the image data.

3. The apparatus according to claim 2, wherein the control means causes the display means to display the reproduction status of the audio data after displaying the image data for a predetermined time, when the instruction means instructs the display means to display the image data.

4. A data recording and reproducing apparatus comprising:
audio data recording means for recording audio data on a recording medium;
imaging means for generating image data while the audio data recording means is recording the audio data; and
image recording means for recording the image data on the recording medium, in association with that part of the audio data which is recorded the moment the imaging means generated the image data.

5. A data recording and reproducing apparatus capable of reproducing audio data and image data associated with that part of the audio data which is recorded the moment the image data is generated, said apparatus comprising:
display means for displaying an operating status of the apparatus; and
control means for causing the display means to display first information including character data representing a reproduction status of the audio data while the audio data is being reproduced, and for displaying second information including the image data associated with said part of the audio data, when said part of the audio data is reproduced.

6. The apparatus according to claim 5, wherein every time said part of the audio data is reproduced, said control means causes the display means to display the second information for a predetermined time and then the first information upon lapse of the predetermined time.

7. A data recording and reproducing apparatus having a function of recording audio data and image data associated with the audio data, said apparatus comprising:
audio data recording means for recording audio data; and
imaging means imaging means for recording image data in association with a time elapsed in the process of recording the audio data, while the audio data recording means is recording the audio data.

8. A data recording and reproducing apparatus having a function of recording audio data and image data associated with the audio data, said apparatus comprising:
audio data reproducing means for reproducing audio data; and
display means for displaying, while the audio data reproducing means is reproducing audio data, first information including character data representing reproduction status of the audio data and for displaying second information including image data associated with a time elapsed in the process of recording the audio data that the audio data reproducing means is reproducing.

9. The apparatus according to claim 8, wherein every time the time elapsed in the process of recording the audio data is detected, the display means displays the image data for a predetermined time and then displays a reproduction status of the audio data.

10. A data recording and reproducing apparatus comprising:
an audio recording section which converts audio signals to audio data and which records the audio data in a memory;
an image recording section which encodes image signals generated by an imaging device, into image data, and which records the image data in the memory;
an index information recording section which records index information about the audio data, said index information including data about the image data associated with the audio data.

11. The apparatus according to claim 10, wherein the index information includes at least one data item selected from the group consisting of data representing the address at which the audio data is recorded in the memory, a total number of image data items associated with the audio data and data representing the time at which the image associated with the audio data is acquired.

12. A data recording and reproducing apparatus comprising:
a sound reproducing section which converts audio data recorded in a memory, into audio signals, thereby reproducing the audio data;
an image reproducing section which converts the audio data recorded in the memory, into image signals, and causing a display device to display the image data; and
control section which controls the image reproducing section in accordance with index information about the audio data recorded in the memory, while the sound reproducing section is reproducing the audio signals.

13. The apparatus according to claim 12, wherein the control means causes the image reproducing section to read from the memory the image data associated with the audio data that the sound reproducing section is reproducing, thereby to reproduce the image data, while the sound reproducing section is reproducing audio data.

14. The apparatus according to claim 13, wherein the control means controls causes the image reproducing section to reproduce the image data when the audio reproducing section reproduces that part of the audio data which is associated with the image data.

15. The apparatus according to claim 14, wherein the control means determines whether that part of the audio data which is associated with the image data has been reproduced, in accordance with data items representing the time when the recording of the audio data was started, the time elapsed from the start of recording the audio data and the time when the image data was acquired, before causing the image reproducing section to reproduce the image data.

16. The apparatus according to claim 14, wherein the control means causes the display device to display the image data for only a predetermined period from the start of reproducing the image data.
